(19) United States
(12) Patent Application Publication
(10) Pub. No.: US 2017/0265371 A1
(43) Pub. Date: Sep. 21, 2017

(54) Crabgrass & Weed EXtracTOR Drill Bit

(71) Applicant: Carl Edwin Smith, Jr., Harlan, KY (US)

(72) Inventor: Carl Edwin Smith, Jr., Harlan, KY (US)

(21) Appl. No.: 15/382,597

(22) Filed: Dec. 16, 2016

Related U.S. Application Data
(60) Provisional application No. 62/242,977, filed on Oct. 16, 2015.

(51) Int. Cl. A01B 1/16

(52) U.S. Cl. CPC A01B 1/165

(57) ABSTRACT

The disclosed invention describes a device and means for removing weeds and the like from the ground. The device is a simply attachment for a drill. The device comprises a body with a shaft protruding from the center and at least two prongs protruding from the opposite side of the body at distances equidistant from the center. The free end of the shaft is placed into a drill and the prongs are forced into the ground so that they are placed around a weed. The user operates the drill, spinning the prongs around the weed. The prongs entangle the weeds roots and bore a small hole in the ground, allowing the user to easily remove the weed. The prongs are then placed into the ground close to the hole and the drill is slowly operated, thus refilling the hole.

### CROSS REFERENCE TO RELATED APPLICATIONS

This Nonprovisional Utility Patent Application claims the benefit of Provision Patent Application No. 62/242,977, filed on Oct. 16, 2015, on behalf of the same inventor of this current Nonprovisional Patent Application, Carl Edwin Smith, Jr., conditioned upon approval of the Petition To Restore the Benefit of the Priority Date of said provisional patent, filed contemporaneously with this application.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

The inventor's local golf course's greens had an unusually high amount of crabgrass during the summer and fall of 2015 growing in all ten greens (nine-hole course and one practice putting green). He and his colleagues were preparing the course to host a “Ryder Cup” event with a friendly rival community in his region. His country club had been on shaky grounds financially and able to employ only one full-time grounds crewman/greens superintendent. The club was financially unable to buy pre-emergent crabgrass killer, and the greens superintendent didn't have time to try to pull the crabgrass. When the inventor was playing or practicing, he would try to use a divot fixer tool, twisting it then pulling upwards and grasping the central area of the crabgrass with his other thumb and index finger. After doing this twenty or thirty times (especially when extracting some from the “fringe”, an area of grass around the green that is allowed to grow somewhat higher therefore the roots grow somewhat deeper—crabgrass located on the fringe on top of the ground is bigger, thicker, wider and grows deeper into the ground), it was not unusual for a couple of tendons in each of his wrists to be sore for several days. September of 2015 was a particularly ideal time for crabgrass to proliferate on the golf course's putting greens. The inventor suddenly thought of the idea of a crabgrass removal drill bit. He placed a standard 4 cm long drill bit proximally in the same axis as the prong/tines on a typical golf divot fixing tool, gluing them together with J-B Weld® Original Cold Weld Formula Steel Reinforced Epoxy. He would use this two-pronged instrument to puncture either side of an individual crabgrass root, thereby straddling the weed. He saw the potential for this, as there are thousands of golf courses across the world, and his wife has a flowerbed full of flowers and unwanted grasses/weeds/vines. He and his three children have a “Victory Garden” full of produce and crabgrass and weeds. The yard adjacent to his swimming pool became all crabgrass in the summer of 2015, due to the fact that the winter pool cover had been laid on the grass to dry. Three weeks later all the normal grass was dead, and crabgrass is typically the first invader of a barren area.

Once crabgrass is established, chemicals are of no use. In the fall, after a heavy frost, crabgrass thighs become an ugly brown piece of grass that by the springtime months of March and April results in a barren area that is fertile ground for crabgrass seed. It is reported that one crabgrass plant can produce up to 150,000 seeds per year. Crabgrass does not grow back each year from the roots, but rather from their tiny seeds, which find their way down into the soil. Chemicals are expensive. The human body is prone to “overuse syndromes,” such as “Carpal Tunnel Syndrome,” when performing a particular movement on a repetitive basis (an example is with a baseball pitcher's rotator cuff and elbow).

The inventor searched local stores, Google, as well as eBay and Amazon.com, finding nothing on the market like his invention. He searched the US Patent office database and was pleased to find this was uncharted territory. He spoke with golf course superintendents and experienced players and found that there was nothing that they suggested other than pre-emergent chemicals and extracting the crabgrass, if so desired, with the stab of a knife or by the use of a golf ball divot fixing tool that is used to repair ball marks made when a ball lands on a golf putting green. Having played golf for 54 years, the inventor was well aware that there was nothing on the market like the weed removal drill bit that he has invented.

Chemical weed killers may kill more than the intended target. In particular, the grass on golf putting greens is cut at about 3/16 inch or less. The longer the grass grows, the deeper and longer its roots become. Conversely, when grass is cut very short, such as on a golf putting green, the grass root structure is very short. This makes the grass on golf course putting greens very delicate, thus easily injured by chemicals, adverse weather conditions, and heavy foot traffic.

Using weed killers in a vegetable garden can be potentially dangerous. The use of chemicals in flower gardens is also filled with potential disasters.

Manual weed removal can be painful on several parts of the body (fingers, wrists, hands, back, and knees) and mentally frustrating. It is labor-intensive and, therefore, can be costly.

Utilizing his tool, the inventor has been able to extract 101 pieces of crabgrass on a putting green in 5 minutes (20.2 crabgrass per minute) in one trial and 88 in another 5-minute trial (17.6 crabgrass per minute). It only takes him about 2 minutes to repair 101 holes created by a 5-minute extraction.

The amount of force/pull needed to extract larger growths of crabgrass from the fringe of the golf putting green is significant (the collar of grass that encircles the green, typically being 2-10 feet in width; the grass here is slightly longer than that on the golf green putting surface, usually cut to the same length as the “teeing ground” of the golf course, but very short compared to the “fairway” and, especially, the “rough”, which is typically allowed to grow 2 inches to 6 inches in length). Removing crabgrass from the “fairway” is arduous, even for an athletic adult male. Removing Dallisgrass, crabgrass, and goosegrass can be tough work and tough on the body. Goosegrass in 2015 has become one of the top problem weeds for golf course superintendents. It is resistant to multiple chemicals, and, therefore, physical extraction is the method through which it can be controlled.

The use of existing hand weeding tools does not offer the advantages of the present invention, delineated above. The inventor has had overwhelmingly positive feedback, seeing smiles of amazement from golfers, golf pros, and golf course superintendents.

“Hole Saws” are saw-toothed cookie-cutters attached to a drill bit running down its center through the thin-walled cylinder used to cut holes of various diameters, often 0.5 inch up to 2 inches—an example being a hole saw used to cut out a hole in a door to a home or office in order to install a doorknob. They are dysfunctional in removing a weed for 2 reasons: removal of the core of earth/weed from within it's cylinder is time-consuming and cumbersome; and the entirety of the leaves of the weed, which may grow 1 to 1.5 inches in length outward horizontally across the surface of the putting green like the spokes of a bicycle wheel, need to be extracted. These leaves actually provide a mechanical advantage to the present “Weed EXtracTOR” in that they wrap snugly around the outer edge of the prongs (unless you press the trigger of the a 12 or higher volt drill full-throttle thereby shearing through these spokes/leaves). These leaves wind up being wrapped around prongs at the top of the core earth/tap root. As the operator pulls the “Weed EXtracTOR” out of the green, the leaves still attached to the tap root virtually ensure that the core of earth/tap root comes out of the green snugly attached to the prongs as opposed to pulling the “Weed EXtracTOR” out of the earthen golf course green yet leaving the entire weed in the green. Additionally the operator can grasp the top of this core with his or her thumb and index finger without his or her fingers being in dirt every time and can easily slide this core out of the “Weed EXtracTOR.”

A search of the USPTO patent database reveals several patents that tackle the problem of weeding in similar ways, but none of these patents describe a device that is as simple and easy to manufacture as this invention, while also utilizing a motorized means of operation. In addition, this invention can be used to repair the hole that is left after a weed or other plant is removed from the ground.

U.S. Pat. No. 3,847,227 (Myers), U.S. Pat. No. 4,603,744 (Ramirez), U.S. Pat. No. 4,641,712 (Cravotta), U.S. Pat. No. 5,207,466 (Ohlson), U.S. Pat. No. 5,261,496 (Smotherman), U.S. Pat. No. 5,330,010 (Smotherman), U.S. Pat. No. 5,441,118 (Cruz, Jr.), U.S. Pat. No. 5,452,767 (Smotherman), U.S. Pat. No. 5,469,923 (Visser), and U.S. Pat. No. 8,714,277 (Lindh) all disclose garden tools designed to bore holes or extract weeds or grasses through means of circular rotation, but each of the described tools are operated by manual means, and each of them, with the exception of U.S. Pat. No. 8,714,277 (Lindh), are of a more complicated design than that of the present invention and would be more difficult to manufacture than the present invention. U.S. Pat. No. 3,554,293 (Aman and Rowell), U.S. Pat. No. 4,213,504 (Schneider), and U.S. Pat. No. 6,595,298 (Crady), disclose garden tools for weeding or soil-working and all utilize a hand-operated drill as their rotating means, but each of said tools are of a significantly more complicated design than that of the present invention and would be more difficult to manufacture than the present invention. U.S. Pat. No. 6,736,217 (Brown) discloses a weed, root, and vine removing, and soil cultivating tool, that can be rotated by a manual means or through the use of a hand-held drill, but it is of a significantly more complicated design that that of the present invention and would be more difficult to manufacture than the present invention. U.S. Pat. No. 8,813,862 (Yamaoka et al.) and U.S. Pat. No. 8,820,426 (Lv) both disclose weeding devices, but both of these devices have integral mechanical means of rotation, are of a significantly more complicated design that that of the present invention, and would be more difficult to manufacture than the present invention. U.S. Pat. No. 7,451,832 (Delvo) discloses a weed remover attachment that works through rotating means, but it is attached to an electric weed trimmer and would be more difficult to manufacture than the present invention. U.S. Pat. No. 6,722,444 (McKill) discloses a tilling and weed removing device that works similarly to the present invention, but it is of a different design in that it utilizes prongs that are bent and does not utilize a body in order to attach said prongs to the shaft of the device. None of the patented weed removers are of any use on a golf course putting green due to the fact that they would cause unacceptable damage to such a tediously maintained and closely mowed putting surface.

### BRIEF SUMMARY OF THE INVENTION

The present invention is a sturdy weeding tool device, in a variety of sizes, designed to remove various weeds and grasses when used as an attachment to a drill. It can also be used to prepare soil for seedlings (examples being tomato plant seedlings and flower seedlings in the springtime). The device is especially good for removing weeds that have a “tap root”, without causing significant disturbance to immediately adjacent grass turf and sub-soil. The device can remove weeds with lengthy tap-roots, average-depth bushy-hair roots, and near-surface vine-type roots, as well as surface growth of weeds, grasses, and vines. The device comprises a shaft, a body, and at least two prongs. The shaft is connected to one side of the body, and the prongs are connected to the opposite side of the body and point in the opposite direction than the shaft. The shaft is connected to the center of the side of the body to which it is attached. The prongs are connected to the opposite side of the body in such a way that the prongs are not at the center of the body, but each prong is equidistant from the center of the body (i.e., every prong is at an equal distance from the center of said body as every other prong). The shaft is shaped in such a way that it will fit into the chuck of a drill (the drill bit receptacle) like a standard drill bit—substantially circular, hexagonal, or other equilateral shape, in cross-section—so that it can easily fit into a standard household battery-powered drill, electric drill, or a manually powered drill of like size. When the shaft is inserted into a drill, it extends from the drill to the body of the device, and two or more prongs extend from the side of the body of the device opposite the shaft. The prongs are straight and elongated, substantially like nails, and may be circular, square, rectangular, hexagonal, or otherwise geometrically shaped in cross-section, with the proximal and distal ends being of the same size, or with the distal end being smaller in cross-section than the proximal end. The surface of the prongs can be smooth or can have ridges like the threads of a screw, or can be otherwise fluted or textured. When the shaft of the device is inserted into the chuck (drill bit receptacle) of a drill, the prongs will point away from the drill. Because the shaft is connected to the center of the body of the device, and the prongs are not connected to the center of the device (but are each equidistant from the center), when the drill is operated, the shaft rotates like any drill bit would rotate, and the prongs travel around the line of rotation in a circular motion. In order to use the device to remove weeds or the like, one must simply insert the shaft into a common drill, push the tips of the prongs into the ground around the weed to be removed, and slowly operate the drill. The prongs will bore a cylindrical hole around the weed, capturing the weed's root structure and freeing the weed from the surrounding earth. When the drill is pulled away from the ground with the device, the weed will come out of the ground, leaving a small, easily reparable hole in its place. The hole in the ground can be easily repaired with the invention. To repair such a hole, one must simply push the prongs into the ground substantially ½ of an inch from the hole and operate the drill so that it slowly turns substantially 15 degrees. Once this is done substantially two or three times from different locations that are substantially ½ of an inch away from the hole, the hole will be filled with earth, and the ground surface will have suffered minimal damage. The device can also bore holes in the ground, in order to prepare the soil for seedlings, by simply pushing the prongs into the ground and operating the attached drill.

The shaft can be of varying lengths, but it is perhaps most useful when it long enough so that the user can pierce the ground with the prongs from a substantially upright, standing position. The user can push the prongs into the ground by stepping on the body of the device, then he or she can operate the drill to remove the weed.

In an alternate process of using the device, the prongs are placed into above-ground weeds, grasses, or vines without penetrating the ground. When the drill is operated, the prongs grab and entangle said weeds, grasses, or vines and rip them out of the ground or rosebush, or off the outside wall of a house or out of its gutters.

### BRIEF DESCRIPTION OF THE DRAWINGS

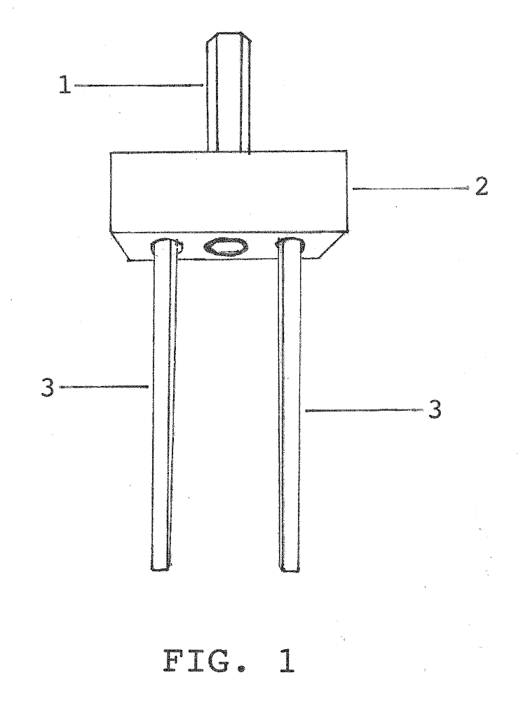

The drawing in FIG. 1 shows the invention from an angle that reveals all of the functional parts. This particular drawing is of the invention as it is currently being produced, as described below. The shaft 1 protrudes from the top of the body 2. The top of the shaft 1 (from the perspective of this drawing) fits into the chuck (drill bit receptacle) of an electric drill (not illustrated). The two prongs 3 protrude from the bottom of the body 2. Though this diagram shows a short shaft 1, the preferred embodiment is one in which the shaft 1 is long enough to allow the user to utilize the invention from a standing, substantially upright position. Thus the shaft 1 should be long enough to extend from a drill in a standing, substantially upright person's hand to the ground.

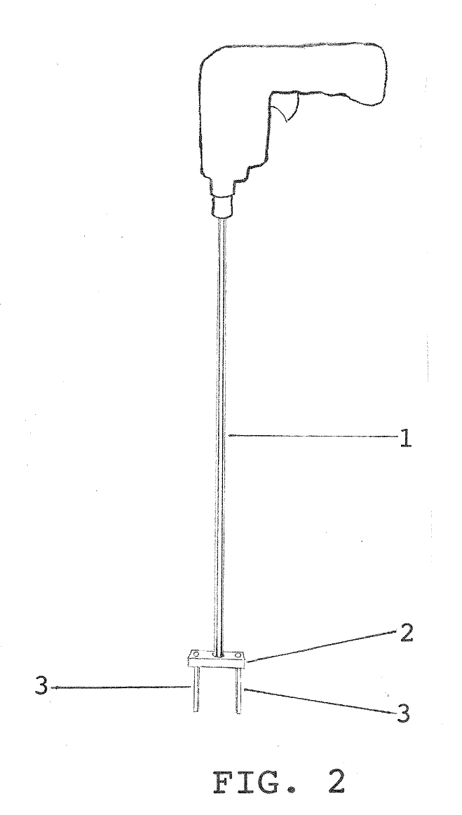

The drawing in FIG. 2 shows the device with a longer shaft 1 extending from the body 2 to the chuck of an electric drill. Two prongs 3 extend towards the ground from the opposite side of the body 2 than that from which the shaft 1 extends.

### DETAILED DESCRIPTION OF THE INVENTION

The device is a weeding and soil preparation tool device comprising a shaft 1, a body 2, and at least two prongs 3. The shaft 1 is connected to one side of the body 2, and the prongs 3 are connected to the opposite side of the body 2 and point in the opposite direction than the shaft 1. The shaft 1 is connected to the center of one side of the body 2. The prongs 3 are connected to the opposite side of the body 2 in such a way that the prongs 3 are not at the center of the body 2, but each prong 3 is equidistant from the center of the body 2 (i.e., every prong 3 is at an equal distance from the center of said body 2 as every other prong 3). The shaft 1 is shaped in such a way that it will fit into the chuck of a drill (the drill bit receptacle) like a standard drill bit—substantially circular, hexagonal, or other equilateral shape, in cross-section—so that it can easily fit into a standard household battery-powered drill, electric drill, or a manually powered drill of like size. When the shaft 1 is inserted into a drill, it extends from the drill to the body 2 of the device, and two or more prongs 3 extend from the side of the body 2 of the device opposite the shaft 1. The prongs 3 are straight and elongated, substantially like nails, and may be circular, square, rectangular, hexagonal or otherwise geometrically shaped in cross-section with the proximal and distal ends being of the same size or with the distal end being smaller in cross-section than the proximal end. The surface of the prongs 3 can be smooth or can have ridges like the threads of a screw, or can be otherwise fluted or textured. The prongs 3 can have other similar shapes while remaining consistent with the teachings of the present invention. When the shaft 1 of the device is inserted into the chuck (drill bit receptacle) of a drill, the prongs 3 will point away from the drill. Because the shaft 1 is connected to the center of the body 2 of the device, and the prongs 3 are not connected to the center of the device, but are each equidistant from the center, when the drill is operated, the shaft 1 rotates like any drill bit would rotate, and the prongs 3 travel around the line of rotation in a circular motion. In order to use the device to remove weeds or the like, one must simply insert the shaft 1 into a common drill, push the tips of the prongs 3 into the ground around the weed to be removed, and slowly operate the drill. The prongs 3 will bore a cylindrical hole around the weed, capturing the weed's root structure and freeing the weed from the surrounding earth. When the drill is pulled away from the ground with the device, the weed will come out of the ground, leaving a small, easily reparable hole in its place. The hole in the ground can be easily repaired with the present invention. To repair such a hole, one must simply push the prongs 3 into the ground substantially ½ of an inch from the hole and operate the drill so that it turns substantially 15 degrees. Once this is done substantially two or three times from different locations that are substantially ½ of an inch away from the hole, the hole will be filled with earth, and the ground surface will have suffered minimal damage. The device can also bore holes in the ground, in order to prepare the soil for seedlings, by simply inserting the prongs 3 into the ground and operating the attached drill.

In an alternate process of using the device, the prongs 3 are placed into above-ground weeds, grasses, or vines without penetrating the ground. When the drill is operated, the prongs 3 grab and entangle said weeds, grasses, or vines and rip them out of the ground or rosebush, or off the outside wall of a house or out of its gutters.

The device can be made of any hard, sturdy material, including, but not limited to, medium grade strength steel. If the device is used only on golf putting greens the material need not be as sturdy. The device can be manufactured utilizing a simple mold, by pouring molten metal into a mold (casting). Alternatively, the device can be manufactured from two pieces spot-welded together: the shaft 1 from a bar of hexagonal steel and the body 2 and prongs 3 from a mold. Also, the device can be manufacturing using any other method that is known in the art, including, but not limited to, machining the shaft 1 and prongs 3 from existing steel stock and welding them to a body 2 made by casting, machining all of the parts from existing steel stock and welding them together, or any combination of casting and machining parts and welding them together. Separate parts can also be attached using other forms of adhesion, other than welding, that are known in the art.

The device can also be manufactured by stamping the body 2 and two prongs 3 out of single piece of sheet metal, with said piece of sheet metal having flaps extending away from the center of the body 2 beyond each of the prongs 3. The flaps can then be folded and pressed back towards the center of the body 2 along the center of the prongs 3, thus creating a body 2 and prongs 3 that are twice as thick as the original piece of sheet metal. When said flaps are folded towards the center of the body 2, they should reach the center point of the body 2, or should slightly overlap, and should be folded over the shaft 1 (as said shaft is described above) to hold the shaft 1 in place in the center of the body 2, parallel to the prongs 3, and extending from the opposite side of the body 2 than that from which the prongs 3 extend.

In practice, the inventor has produced the invention as follows: the body 2 is made by cutting a substantially 1 and ½ inch long section of ½-inch wide by ½-inch deep stock steel bar. Two substantially 3/16-inch holes are drilled through the body 2 such that each hole is equidistant from the center of the length of the body 2. The edges of such holes that are proximal to the center of the length of the body 2 are substantially 9/16 inch apart, and the edges of such holes that are distal to the center of the length of the body 2 are substantially 15/16 inch apart. A third hole that is substantially ¼-inch wide is drilled through the center of the length of said body 2. Each hole is centered along the ½-inch width of said body 2. A 1 and ¼ inch section of a ¼-inch wide piece of a stock straight hexagonal steel rod is hammered into the center hole, so that the proximal end of said rod is flush with the bottom surface of the body 2, and the distal end protrudes ¾ inch from the top surface of the body 2. A tapered, substantially rectangular-in-cross-section masonry/concrete nail (2 and ½ inches long and 6/32 inches wide at the wider end and 4/32 inches wide at the narrower end) is hammered into each of the non-centered holes, being hammered through the holes (with the narrower ends going into the holes first) from the side of the body 2 where the shaft 1 is protruding and being hammered until the wider end of the masonry nails are flush with the surface of the body 2 from which the shaft 1 protrudes, and the masonry nails (prongs 3) protrude 2 inches from the body 2 in the opposite direction from which the shaft 1 protrudes. In this embodiment, the centers of the cross-sections of the prongs 3 are substantially 12/16 inches apart. The prongs 3 are equidistant from the center of the body 2 and parallel to each other and coplanar to the shaft 1. If the prongs 3 taper and are narrower on the distal end, it is the central vector of each prong 3 (the vector formed by a line from the center of the cross-section of the wider end of the prong 3 to the center of the cross-section of the narrower end of the prong 3) that is parallel to the central vector of the other prong 3 and coplanar to the shaft 1. The line of rotation of the shaft 1 is directly in between the vectors of the prongs 3 and is parallel to the vectors of the prongs 3. The end of the shaft 1 and the ends of the masonry nails (which serve as the prongs 3) are then spot-welded to the body 2 where they are flush with the body 2. If a longer shaft 1 is used (perhaps a 22-inch to 26-inch shaft 1—with said shafts 1 protruding from 21 and ½ inches to 25 and ½ inches from the body 2, respectively), so that the device can be operated from a substantially upright, standing position, the body 2 is longer (substantially 1 and ¾ inches long), and the edges of the outer holes that are proximal to the center of the length of the body 2 are substantially 14/16 inch apart, and the edges of said holes that are distal to the center of the length of the body 2 are substantially 18/16 inch apart. In this embodiment, the centers of the cross-sections of the prongs 3 are substantially 1 inch apart. The longer body 2 makes it easier to step on the body 2 to force the prongs 3 into the earth. It may be preferable to have a body 2 that is 2 inches long when making the device with the longer shaft 1, while correspondingly making the prongs 3 an additional ¼ inch apart (thus making the centers of the cross-sections of the prongs 3 substantially 1 and ¼ inches apart). Note that these specific dimensions are illustrative, rather than limiting.

The number of prongs 3 can vary. The 2-prong version will be the most commonly utilized design, but 3 and 4 prong versions in certain circumstances will have more functionality when dealing with larger, more-stout weeds. However, any number of prongs 3 can be used on a device like the present invention while remaining consistent with the teachings of the present invention.

Looking up the axis of the shaft 1, toward the chuck of the drill to which it is attached, the prongs 3 of the 2-prong version would ideally be located at the 3 o'clock and 9 o'clock positions, if one imagines a clock face, making the prongs 3 180° apart on an imagined clock face numbered from 1 through 12 with the 12 o'clock position being at the top, the 3 o'clock position being rotated 90° clockwise, the 6 o'clock position being an additional 90° clockwise (thereby being located at the bottom of the clock), and the 9 o'clock position being located an additional 90° clockwise (the clock face being 360°). The 3-prong version would ideally have its prongs 3 located at the 12 o'clock, 4 o'clock, and 8 o'clock positions (120° between each prong 3 going around the clock). The 4-prong version would ideally have its prongs 3 located at the 12 o'clock, 3 o'clock, o'clock, and 9 o'clock positions (90° between each prong 3 going around the clock). However, any number of prongs 3 can be placed in a variety of positions while remaining consistent with the teachings of the present invention.

Though the device as described can be used with a hand-held drill, a significantly larger version of the device could be used with a larger drill, or other rotating machine, while remaining consistent with the teachings of the present invention. Such a larger device could be used to remove bushes or even trees, while retaining a significant portion of their root structure.

Also, an automated array of the devices can be attached to the underside of a riding lawnmower or similar vehicle. An array of the devices would replace the rotating lawnmower blade and would be operated mechanically by the vehicle's motor, or other mechanical means, and could extract multiple weeds in unison.

The beauty of this design lies in its ability to rapidly extract the weed in question without disturbing the surrounding area, leaving a small cylindrical hole that is easily repaired and utilizing the same tool to repair the hole by punching it into the area surrounding the hole in two or more locations (for instance at the 12 o'clock and 6 o'clock positions around the hole) and gently, briefly squeezing the trigger on a variable speed drill in order for it to turn substantially 15 degrees. In the golf green application, a 3.6-volt or 4-volt battery-powered drill supplies the ideal amount of energy; the 3.6 and 4-volt sizes are light-weight (in particular, drills with a lithium battery rather a nickel cadmium battery), easy to use, and very portable. The device can be used in damp or wet conditions. This is of extreme importance in removing weeds from putting greens used in the sport of golf (as said putting greens are located in outdoor, potentially damp or rainy environments on a golf course), a practice facility, or at a single-home dwelling practice putting green.

When using the larger sized (or large-gap) versions of the device, it is better to use a 12, 18, or 20-volt lithium battery drill.

A version of the device with prongs 3 that are longer and further apart would be well suited to clear an area grown up with grasses/weeds/vines. The prongs 3 of the device should be placed in the midst of the grass/weeds/vines (not into the ground) in order to wind the grass/weeds/vines like cotton candy is wound around a stick. Utilizing this larger version of the device enables one to pull a lot of weeds and long grasses out without having to do so completely manually. It is likely that the operator will still need to manually pull up on the drill itself in order to free the mass of grasses/weeds/vines wound around the large weeding drill bit from its attachments to the ground. The advantage of using the device is that the grasses/weeds/vines do not have to be gathered from the ground by hand one at a time, but rather can be removed in bunches, thus avoiding thorns and snakes.

Versions of the device that have their prongs 3 designed like a “screw thread” (with spiraled elevated ridges running down each prong) or like a drill bit (with spiraled flutes running down each prong) enable the device to have a better grasp of the weed or grass structures or vines. The screw thread version is not necessary for use on golf putting greens. A screw thread is an elevation or “ridge” wrapped diagonally around and down (in a helical pattern) the cylindrical or conical prongs 3, with said thread on a cylindrical prong 3 being called a “straight thread” and on a conical prong 3 being called a “tapered thread.” Prongs 3 designed like a standard drill bit have recessed grooves called “flutes” (instead of elevations) helically spiraling down the axis of each prong 3.

What is claimed is:

1. A weed removing and soil preparation device comprising:
(a) a body; and
(b) a straight rotatable shaft having an upper and lower end, the lower end being centrally attached to said body and the upper end being attachable to a chuck of a rotary drill; and
(c) two or more straight prongs having upper and lower ends, the upper ends being attached to said body peripherally from said body's center and the lower ends extending in the opposite direction from said body than said shaft, with each prong being equidistant from the center of said body and parallel to each other and coplanar to the vector of said shaft.

2. The weed removing and soil preparation device disclosed in claim 1 wherein the body is substantially 1 and ½ inches long, ½ inch wide, and ½ inch deep, the shaft is substantially ¼ wide and protrudes substantially ¾ inch from the body, the prongs taper from substantially 6/32 inch wide at the proximal end to substantially 4/32 inch wide at the distal end and protrude substantially 2 inches from the body, and the center of the cross-section of the prongs are substantially 12/16 inch apart.

3. The weed removing and soil preparation device disclosed in claim 1 wherein the body is substantially 1 and ¾ inches long, ½ inch wide, and ½ inch deep, the shaft is substantially ¼ wide and protrudes substantially 21 and ½ to 25 and ½ inches from the body, the prongs taper from substantially 6/32 inch wide at the proximal end to substantially 4/32 inch wide at the distal end and protrude substantially 2 inches from the body, and the center of the cross-section of the prongs are substantially 1 inch apart.

4. The weed removing and soil preparation device disclosed in claim 1 wherein the body is substantially 2 inches long, ½ inch wide, and ½ inch deep, the shaft is substantially ¼ wide and protrudes substantially 21 and ½ to 25 and ½ inches from the body, the prongs taper from substantially 6/32 inch wide at the proximal end to substantially 4/32 inch wide at the distal end and protrude substantially 2 inches from the body, and the center of the cross-section of the prongs are substantially 1 and ¼ inch apart.
